(19) United States
(12) Patent Application Publication
(10) Pub. No.: US 2017/0352153 A1
(43) Pub. Date: Dec. 7, 2017

(54) Method and apparatus for the morphometric analysis of cells of a corneal endothelium

(71) Applicant: Universitá degli Studi di MIlano - Bicocca, Milano (IT)

(72) Inventors: Alessandro BORGHESI, Pavia (IT); Silvia TAVAZZI, Como (IT); Lorenzo FERRARO, Marcignago (IT); Federica COZZA, Albese con Cassano-Como (IT)

(21) Appl. No.: 15/541,373

(22) PCT Filed: Feb. 2, 2016
(86) PCT No.: PCT/IB2016/000074

§ 371 Date: Jul. 1, 2017

(30) Foreign Application Priority Data
Feb. 10, 2015 (IT) MI2015A000182

(51) Int. Cl. G06T 7/00; G06T 7/90

(52) U.S. Cl. CPC G06T 7/0012; G06T 7/90; G06T 2207/10056; G06T 2207/30041; G06T 2207/20152

(57) ABSTRACT

The present invention relates to a method and apparatus for the morphometric analysis of endothelial cells, which is based on the use of an image taken from a camera connected to a biomicroscope which is digitally reprocessed and subsequently analyzed.

The present invention relates to a method and relative apparatus for the morphometric analysis of the cells of the corneal endothelium.

The definition “morphometric analysis of the cells of the corneal endothelium” refers to an analysis suitable for providing, as a result, at least some of the following parameters:

measurement of the area of each cell of the endothelium in a selected area,

number of cells per area unit of the endothelium in number of cells p,

number of cells per area unit of the endothelium in a selected area,

identification of the form of each cell in identification of the endothelium,

identification of the form of each cell in a selected area of the endothelium,

possible statistical analyses relating to said cells.

Said analysis of the endothelium can be particularly applied, for example, in the preparation of cataract surgery, in refractive surgery, in corneal diseases, in corneal transplants and in the field of contact lens wearers.

The endothelium has the main function of preserving the transparency of the cornea; it is particularly important to effect both a qualitative and quantitative analysis of this tissue as it does not have a regenerative capacity and is therefore subject to morphological changes.

For this reason, in the state of the art, the morphometrical analysis of the corneal endothelium is carried out with the use of a specific instrument, the so-called endothelial microscope, i.e. an apparatus specifically destined for effecting the analysis of this tissue.

There are various types of endothelial microscopes, among these one of the most widely used is of the non-contact” or “specular” type, known per se in the state of the art and consequently no further details will be provided in this respect.

Without entering into a description of endothelial microscopes, it should be noted that they have some common limitations regardless of the type.

First of all, endothelial microscopes have a relatively high cost, mainly deriving from the components of which they are composed (i.e. light source, various optics, detector, mechanical components); this cost makes them relatively uncommon, with obvious consequences.

Secondly, endothelial microscopes can only acquire the image of the endothelium in the most central portion of the cornea; furthermore, the operator does not have the possibility of accurately choosing which area to examine, as he does not have full control of the positioning of the sensor with respect to the cornea.

Another limitation of this apparatus lies in the fact that the image acquired has fixed dimensions (typically 0.1 mm²), which depend on the amplitude of the incident light beam, that cannot be modified by the operator.

Endothelial microscopes, moreover, do not allow acquisition in real time of the area of interest and consequently a clinical evaluation requires a complete examination on the part of the instrument before proceeding with any analysis of the results of the examination.

In general, it should be noted that in the present state of the art a non-morphometric but only qualitative analysis of the endothelium can also be effected—for an experienced clinician (typically an ophthalmologist or optometrist)—with the use of a biomicroscope (also indicated as slit lamp).

Equipping a biomicroscope with a photographic camera for registering the real photographic image corresponding to the area visualized by the clinician during the examination, is also known in the state of the art.

Although biomicroscopes—having a relatively low cost—are widely used, there are limitations however in acquiring data of the endothelium using this type of apparatus.

In the present state of the art, in fact, they do not allow a morphometric analysis in the sense specified above, but only a qualitative analysis, as the images acquired of the corneal endothelium do not have suitable characteristics for being analyzed by known software.

In short, there are therefore two approaches in the state of the art for investigating the corneal endothelium: the use of an endothelial microscope (which allows a true morphometric analysis, but which is costly and therefore not widely used, in addition to having other problems) and the use of a biomicroscope (widely used in ophthalmologic and optometric clinical practice for other types of evaluations but which in any case only allows a qualitative analysis of the corneal endothelium).

Even if the analysis techniques adopted by endothelial microscopes were to be used on the images acquired by biomicroscopes, due to the low contrast that is found in the latter, it is not possible to recognize the endothelial cells.

The general objective of the present invention is therefore to provide a method and relative apparatus for the morphometric analysis of the corneal endothelium that has a relatively low cost and which overcomes the. limitations of the solutions known in the state of the art.

The above objectives are achieved, according to the invention, by a method and relative apparatus in accordance with the respective enclosed independent claims.

The basic principle of the invention consists in an innovative method for processing the image acquired by a biomicroscope using non-conventional techniques (which allow a better highlighting of the edges of the corneal endothelium cells).

The general idea relates to a method which briefly comprises the following steps:

(i) acquiring and registering real photographic images of the corneal endothelium cells by means of a (common) biomicroscope with a specific and simple procedure conceived for acquiring the digital image of the cells. It allows the dimension of the incident light beam to be varied, and therefore the amplitude of the area being examined so as to have a number of recognized cells at least 2-3 times greater with respect to that typically obtained with an endothelial microscope; to vary the dimension of the incident light beam and therefore the amplitude of the corneal endothelium cells using a (common) endothelium corneal thelial; furthermore, it offers the possibility of selecting or registering which portion of the cornea has been observed, dividing it into suitable areas;

(ii) morphometric analysis of the area of interest.

In this way, all the limitations described above are therefore overcome; the use of a biomicroscope as part of the analysis apparatus allows the overall cost of the instrumentation to be reduced, also making said analysis simpler to carry out; furthermore, it is possible to become disengaged from subjective elements in the general analysis of the endothelium, allowing a true morphometric analysis to be effected; at the same time, it is also possible to accurately localize the area of interest of the analysis by referring it to a specific portion of the cornea.

The structural and functional characteristics of the invention, and its advantages with respect to the known art will appear more evident from the following description relating to a possible embodiment of the invention according to the innovative principles of the invention itself.

To allow a better understanding of the method of the method of the invention, it would be convenient to first briefly describe the apparatus with which said method is implemented in a preferred but non-limiting embodiment.

In this embodiment, the apparatus of the invention for the morphometric analysis of corneal endothelium cells comprises a biomicroscope, a digital camera, an electronic processor and a monitor.

These components are operatively connected to each other to show the images acquired by the digital camera and the subsequent graphic representations of the calculation operations effected by the processor, in real time on the screen (or monitor).

The latter is a computer, for example, and the method is effected by means of a specific software loaded in a computer memory unit and that can be implemented on the same.

The biomicroscope is also called “slit lamp”: this is a device known per se and does not require any further description herein.

The digital camera is also a well-known device and does not require a technical description herein, except that it should be noted that, for the present application, it is preferably of the type provided with a CCD or Cmos sensor with at least 5 million pixels and a frame rate of at least 5 fps.

The method is first described hereunder in its general embodiment and then in greater detail.

A real image of the corneal endothelium cells is acquired by means of a biomicroscope and digital camera connected to the same and to a personal computer, with a resolution sufficient for the subsequent processing.

For this purpose, it should be noted that a cell is preferably represented by about 60/70 pixels, but theoretically it should also be possible to work with a lower number of pixels.

The technique preferably used for selecting the most suitable image consists in acquiring a variable frame number starting from two frames up to any number “n” and calculating the relative MTF (Modulation Transfer Function) for each of these and, on the basis of the necessity of the software, selecting that with the most suitable value for the subsequent processings.

It should be remembered that the MTF function—in general—is given by the ratio between two contrasts, C1/C0, wherein C1 is the contrast of the image acquired by the sensor of the digital camera (e.g. CCD) and C0 is the contrast of the image before the acquisition process.

In the present case, the relative MTF is calculated by measuring the contrast C0 at time t0 and the contrast C1 at time t1, again after the acquisition process.

In this way, there is a relative MTF measurement between two frames acquired at two different moments, one at the moment t0 and the other at the moment t1.

By repeating the relative MTF measurement for each acquisition (t0, t1, t2 . . . tn), it is possible to evaluate the variation in the MTF moment by moment and therefore position the biomicroscope in the highest-quality area of the image.

For this purpose, the generation of a warning or feedback signal towards the operator is envisaged, who controls the apparatus (for example a sound feedback) determined by the most suitable MTF (Modulation transfer function) value.

In order to favour the acquisition, after the area of interest of the endothelium has been identified by the operator, a centering step can be envisaged, which comprises the phase of maintaining the portion of the endothelium of interest in the centre of the screen or monitor in which it is displayed.

After the acquisition, the area to be analyzed can be selected, for example by selection on the screen, with a frame, and this information can be memorized.

The processing comprises a preliminary modelling of the real image by means of suitable treatment procedures of the image in a fixed sequence.

The image is represented by a matrix of Cartesian coordinate points (x, y) to which a sequence of functions f (x, y) is applied, from which the parameters of interest i.e. the area of each single cell and the number of first nearby cells, are deduced.

The data are finally processed to provide a statistical description of the image, i.e. at least some of the parameters of the morphometric analysis of the corneal endothelium cells.

More specifically, the method for the morphometric analysis of the corneal endothelium cells, comprises the following steps:

A. acquiring a real digital image of corneal endothelium cells in a specific area by means of a bio-microscope equipped with a digital camera, said real digital image being composed of a plurality single pixels,

B. selecting at least one area of interest of said image, preferably an area containing endothelial cells only,

C. detecting a luminance value for each pixel of said area of interest,

D. generating a first matrix whose elements contain a luminance value of the single pixels,

E. modelling said area by reconstructing one or more model cells of the endothelium, effected at least by assignment, to each model cell, of pixels substantially having the same luminance value,

F. calculating, for each model cell, the barycentre of the -pixels of which said cell is composed” and the radius,

G. generating a second matrix 3×N wherein N is the number of cells identified,

H. scanning said matrix 3×N identifying, for each model cell, a nearby model cell which satisfies the relation (d*K)≦(r1+r2), r1 and r2 being the radiuses of the two model cells, d the distance between the barycentres of the two model cells and K a form factor,

(d*K)e, with each model cell, of pixels substantially having the same distance between the barycentres of the two model cells and K a form factor.

I. for each pair of model cells for which the relation of step H has been verified, considering the two model cells of the pair in contact,

calculating the number of model cells per mm² and/or the area of each model cell and/or the average area of the model cells and/or the standard deviation on the area of each model cell with respect to the average area and/or the number of cells touched by a certain cell.

In this way, in short, the morphometric analysis can be effected on the basis of data acquired by the biomicroscope and camera, thus overcoming the limitation linked to the state of the art.

In this way, it is also possible to select the corneal portion whose morphometric analysis is to be effected with precision.

According to an optional and advantageous improvement, step C) comprises the step of applying image analysis filters to the pixels of said area, suitable for eliminating false information and homogenizing the luminance value over a whole cell.

Filters of this type are known in literature; in particular, at least one, preferably all, of the following filters are applied:

Richardson-Lucy:

This is an algorithm based on Bayes' theorem which allows the deconvolution of an image to be effected by means of an iterative process. In general, if Y(i) is a latent “non-confused” image, X(i) the acquired image and P(i|j) the point spread function, it can be said that X(i)=ΣP(i|j)Y(j), wherein j is the actual pixel and i is the pixel. It can be demonstrated that Y(j) can be obtained by means of an iterative process assuming that P(i|j) PSF is known and assuming that the distribution of the photons is a Poisson distribution.

Contrast Enhancement Filter:

The algorithm for obtaining an improvement in the contrast of the image is based on the equalization of the histogram of the luminance values.

Morphology Filter (Erosion, Dilation):

This is an algorithm for image processing based on form analysis. It is based on the use of a structuring element convoluted with the image to be analyzed. The pixel resulting from the convolution has a value depending on the nearby pixel values. Two basic operations are generally used called EROSION and DILATION. In the DILATION operation, pixels on the contours of the image object are summed up. In the EROSION operation pixels are eliminated from the contours of the object in the image.

Segmentation Watershed Filter:

This algorithm was introduced by Luc Vincent and Pierre Soille and is based on the immersion concept. Each local minimum is considered as a hole of a surface. The filling of the basin limited by this surface is simulated until only the crest is visible.

The above filters are known in literature and consequently no further specifications are required.

All of these filters are preferably applied and in a precise order (time, consecutive) defined above.

With respect to the form factor K according to step H). this takes into consideration the fact that the form of each single cell is not perfectly spherical; it preferably ranges from 0.7 to 1, so as to accept, in short, a deviation of up to 30%.

The objectives proposed above have therefore been achieved.

The protection scope of the invention is defined by the following claims.

1. A method for morphometric analysis of corneal endothelium cells comprising the following steps:
A. acquiring at least one real digital image of the corneal endothelium cells with a bio-microscope equipped with a digital camera, said real digital image being composed of a plurality of single pixels;
B. selecting at least one area of interest of said real digital image;
C. detecting a luminance value for each pixel of said area of interest;
D. generating a first matrix having elements that contain a luminance value of the single pixels;
E. modelling said area by reconstructing one or more model cells of the endothelium, effected at least by assignment, to each model cell, of pixels substantially having the same luminance value;
F. calculating, for each model cell, a barycenter of the pixels of which said model cell is composed and a radius thereof;
G. generating a second matrix 3×N wherein N is a number of identified cells;
H. scanning said second matrix 3×N and identifying, for each model cell, a nearby model cell which satisfies a relation (d*K)≦(r1+r2), r1 and r2 being radiuses of the two model cells, d a distance between barycenters of the two model cells, and K a form factor;
I. for each pair of model cells for which the relation of step (H) has been verified, considering the two model cells of the pair of model cells in contact; and
J. calculating one or more of a number of model cells per mm², an area of each model cell, an average area of the model cells, or a standard deviation on the area of each model cell with respect to one or both of the average area or a number of cells touched by a specific cell.

2. The method according to claim 1, wherein step (A) comprises acquiring a plurality of images and selecting a preferred image among the plurality of images acquired by calculation of a relative Modulation Transfer Function (MTF) obtained by measuring contrast of two consecutive images acquired in subsequent times.

3. The method according to claim 2, wherein step (C) comprises a step of applying image analysis filters to the pixels of said area of interest, adapted to eliminate false information and homogenizing a luminance value over an entire cell.

4. The method according to claim 3, wherein said image analysis filters are at least Richardson-Lucy, Contrast Enhancement filter, Morphology filter (erosion, dilation), and Segmentation Watershed filter.

5. The method according to claim 3, wherein the applied filters applied are:
i) Richardson-Lucy,
ii) Contrast Enhancement filter,
iii) Morphology filter (erosion, dilation), and
iv) Segmentation Watershed filter,
said applied filters being applied consecutively a i), ii), iii), iv) order.

6. The method according to claim 1, wherein said form factor K in step (H) ranges from 0.7 to 1.

7. An apparatus for morphometric analysis of a cells of a corneal endothelium, wherein said apparatus is configured to:
A. acquire at least one real digital image of the corneal endothelium cells with a bio-microscope equipped with a digital camera, said real digital image being composed of a plurality of single pixels;
B. select at least one area of interest of said real digital image;
C. detect a luminance value for each pixel of said area of interest
D. generate a first matrix having elements that contain a luminance value of the single pixels;
E. model said area by reconstructing one or more model cells of the endothelium, effected at least by assignment, to each model cell, of pixels substantially having the same luminance value;
F. calculate, for each model cell, a barycenter of the pixels of which said model cell is composed and a radius thereof;
G. generate a second matrix 3×N wherein N is a number of identified cells;
H. scan said second matrix 3×N and identify, for each model cell, a nearby model cell which satisfies a relation (d*K)≦(r1+r2), r1 and r2 being radiuses of the two model cells, d a distance between barycenters of the two model cells, and K a form factor;
I. for each pair of model cells for which the relation of step (H) has been verified, consider the two model cells of the pair of model cells in contact; and
J. calculate one or more of a number of model cells per mm², an area of each model cell, an average area of the model cells, or a standard deviation on the area of each model cell with respect to one or both of the average area or a number of cells touched by a specific cell.

8. The apparatus according to claim 7, further comprising at least an electronic processor and a screen.
